(19) United States
(12) Patent Application Publication
(10) Pub. No.: US 2007/0299820 A1
(43) Pub. Date: Dec. 27, 2007

(54) CRID-based metadata management architecture and service for p2p networks

(76) Inventors: Dennis Bushmitch, Somerset, NJ (US); Rajesh Khandelwal, Bridgewater, NJ (US)

Correspondence Address: GREGORY A. STOBBS, 5445 CORPORATE DRIVE, SUITE 400, TROY, MI, 48098, US

(21) Appl. No.: 11/473,407

(22) Filed: Jun. 22, 2006

(51) Int. Cl. G06F 17/30

(52) U.S. Cl. 707/3

(57) ABSTRACT

A method is provided for retrieving metadata for content residing in a peer-to-peer network. The method includes: determining a content reference identifier for the content; generating a hash value for the content reference identifier; determining location of a metadata service based on the hash value; and retrieving metadata for the content by accessing the metadata service using the content reference identifier

### FIELD

The present disclosure relates to a metadata management architecture and service for peer-to-peer networks.

### BACKGROUND

Peer-to-peer networks typically use ad hoc connections between its participants. Peer-to-peer networks rely on the computing power and bandwidth of the participants in the network rather than concentrating it in a relatively low number of dedicated servers. Thus, as participants arrive and demand on the network increases, the total capacity of the network services also increases in a scalable manner.

Peer-to-peer frameworks do not currently support robust metadata-based content searches. Rather, simple file name-based searches are generally enabled using distributed hash tables (DHT). Thus, there is a need for an advanced metadata search service within the context of peer-to-peer networks. The solution should allow multiple types of metadata to be interrelated and cross-referenced to assist users with additional specificity of search criteria. In addition, a metadata-based search solution should be distributed and highly scalable amongst the participants in the network.

The statements in this section merely provide background information related to the present disclosure and may not constitute prior art.

### SUMMARY

A method is provided for retrieving metadata for content residing in a peer-to-peer network. The method includes: determining a content reference identifier for the content; generating a hash value for that content reference identifier; determining location of a metadata service based on the hash value; and retrieving metadata for the content by accessing the metadata service using the content reference identifier.

Further areas of applicability will become apparent from the description provided herein. It should be understood that the description and specific examples are intended for purposes of illustration only and are not intended to limit the scope of the present disclosure.

### DRAWINGS

FIG. 1 is a diagram depicting a metadata management architecture suitable for use in a peer-to-peer network;

FIG. 2 is a diagram illustrating how a content reference identifier may be used to tie together different types of metadata;

FIG. 3 is a diagram depicting an exemplary stack architecture for implementing an advanced metadata service on a JXTA compliant peer; and

FIG. 4 is a diagram of an exemplary message sequence which may be used by a content requesting application to interact with the metadata management architecture to identify content of interest.

### DETAILED DESCRIPTION

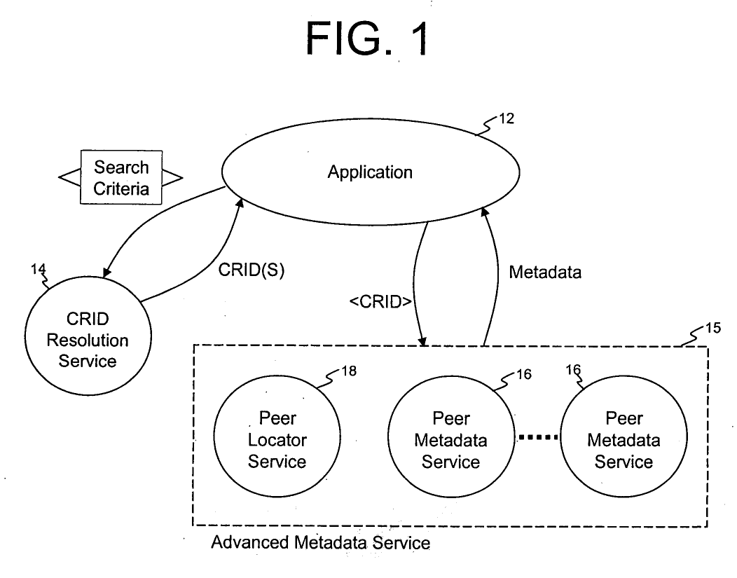

FIG. 1 depicts a metadata management architecture 10 suitable for use in a peer-to-peer network. The metadata management architecture 10 is generally comprised of a CRID resolution service 14 and an advanced metadata service (AMD) 15, where the advanced metadata service 15 further includes a peer locator service 18 and a plurality of peer-based metadata services 16. Rather than being a distinct software entity, it is envisioned that the CRID resolution service 14 may be implemented as an integral component of the advanced metadata service 15. Furthermore, while the metadata management architecture is described in the context of a peer-to-peer network, it is understood that it is suitable for use in other types of network environments.

In operation, each peer in the network can publish its content along with metadata pertaining to the content. The advanced metadata service is responsible for storing the metadata across multiple peers. Other peers in the network can then access the content and/or metadata pertaining to the content using a content identifier in a manner further described below.

In an exemplary embodiment, the metadata management architecture 10 employs the content reference identifier (CRID) as defined in accordance with the TV-anytime specification. CRID provides separation between content reference and content location as well as ties multiple metadata types together for a given piece of content. CRID also provides a reference for content that may not exist yet, but will be available at some later time. However, it is envisioned that other types of content identifiers could also be utilized within the broader aspects of this disclosure.

CRID syntax is Uniform Resource Identifier (URI) compliant. An exemplary syntax for CRID is CRID://<DNSname>;<name_extension>/<data>, where <DNSname>;<name_extension> is an authority name and <data> is a free format string that is also URI compliant as well as meaningful to the specified authority. More specifically, <DNS name> is a registered Internet domain name and must be a fully qualified name according to the rules given by RFC 1591, and <name_extension> is an optional string to enable multiple authorities to use the same DNS name. All <name_extension> elements which share the same DNS name must be unique.

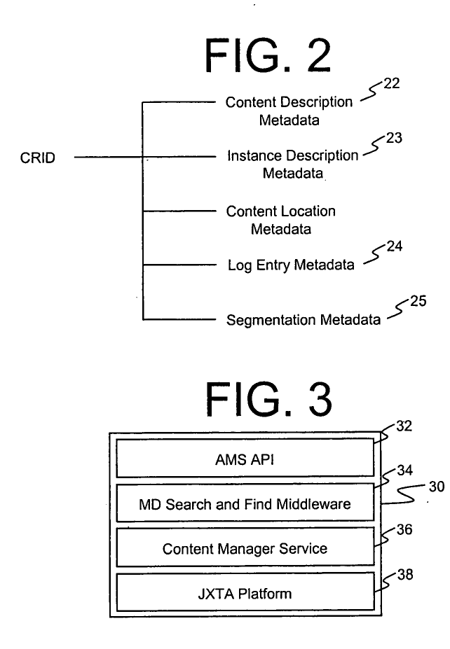

Generally speaking, distributed hash table mechanisms may not be adequate to reference large amounts of related metadata, as the amount of related metadata to which hashes and pointers need to be kept in hash tables could be very large. However, this problem is simplified when CRID is used to tie multiple metadata types together. With reference to FIG. 2, a single CRID may be used to access a general description (title, genre, summary, reviews, etc.) of the content 22, a description for a particular instance (content location, usage rules, delivery parameters, event specific information, etc.) of the content 23, an entry in a usage log 24 and/or individual segments of segmented content 25. Additional metadata types, such as quality-of-service metadata and user preference metadata, may also be introduced for more robust content retrieval.

With continued reference to FIG. 1, the CRID resolution service 14 provides an initial mechanism for peers to learn about content available for referencing within the network. In one exemplary embodiment, peers in a network publish its content along with a content identifier and metadata pertaining to the content. The CRID resolution service 14 in turn learns of the available content and formulates a searchable database for the content indexed by some simple criteria. The database includes a content identifier (e.g., CRID) and simple searchable attributes for each piece of available content. However, it should be noted that the database does not contain any content location metadata for the available content or any other advanced metadata types. It is envisioned that the CRID resolution service may be implemented as a centralized service or in a distributed fashion amongst the peers of the network.

To access a piece of content, a requesting application 12 may first access the CRID resolution service 14. For example, a requesting application may be interested in content having “Star Wars” in the title. In this case, a search query is sent from the requesting application to the CRID resolution service 14. An exemplary search query message is as follows:

```
<?xmlversion=”1.0” encoding=”UTF-8”?>
<tvams:SearchQuery>
    <XPath>
        //ProgramInformation[.//Title contains “Star Wars”]
    </XPath>
</tvams:SearchQuery>
```

In response, the CRID resolution service 15 will send a search response to the requesting application. The response will provide the requesting application with content identifiers for content which meets the search criteria. In this case, content identifiers for content having “Star Wars” in the title. An exemplary search response message is as follows:

```
<?xmlversion=”1.0” encoding=”UTF-8”?>
<tvams:SearchResponse>
<TVAMain>
    <ProgramInformation>
        <ProgramInformation crid=”crid://StarWars-II”>
            <Title> Star Wars II <Title>
            ...
        <ProgramInformation crid=”crid://StarWars-VI”>
            <Title> Star Wars VI <Title>
        ...
    </ProgramInformation>
</TVAMain>
</tvams:SearchResponse>
```

In this way, a requesting application learns of content reference identifiers for available content which may be of interest to the requesting application. Alternatively, it is envisioned that content identifiers for content may be known to a requesting application or learned through other mechanisms.

To learn more about a piece of content, the requesting application 12 may then access the advanced metadata service 15 using its content identifier. As noted above, the advanced metadata service is comprised of a plurality of peer-based metadata services 16 distributed amongst the peers of the network. Each peer-based service 16 is able to resolve content identifiers assigned thereto. Content identifiers are assigned to an individual peer-based metadata service 16 based on a hash value of the content identifier. In other words, each peer-based metadata service 16 is responsible for resolving content identifiers having a hash value within an expected range of hash values assigned thereto. In this way, metadata services are scalable and distributed amongst the peers of the peer-to-peer network.

A peer locator service 18 manages the different ranges of hash values assigned to each peer. In an exemplary embodiment, a peer locator table is used by the peer locator service to maintain a list of peer identifiers (e.g., a network address) and a range of hash values assigned to each peer. It is envisioned that emerging DHT algorithms (e.g., CAN, Chord, Pastry, etc.) can be used to manage the distributed hash references.

In operation, a requesting application 12 passes a content identifier of interest to the advanced metadata service. More specifically, the peer locator service 18 receives the content reference identifier and applies a one-way hash function (e.g., MD5) to the content reference identifier. The peer locator service in turn accesses the peer locator table using the hash value of the content identifier. By accessing the peer locator table 18, the peer locator service 18 learns of the peer-based metadata service 16 which is responsible for the metadata pertaining to the content of interest.

A metadata request is then passed from the peer locator service 16 to the applicable peer-based metadata service 16. In response thereto, the peer-based metadata service 18 retrieves the requested metadata and transmits the metadata to the requesting application 12. Such metadata services are generally known in the art. Further details regarding an exemplary metadata service may be found in International Patent Publication No. WO/2006010107 published on Jan. 26, 2006 and which is incorporated herein by reference.

The metadata management architecture described above may be integrated with JXTA technology. JXTA technology is a set of protocols that have been specifically designed for peer-to-peer networks. Using JXTA protocols, peers can cooperate to form self-organized and self-configured peer groups independently of their positions in the network and without the need for centralized management infrastructure. Because the JXTA protocols are not rigidly defined, their functionality can be extended to support the AMS functions and architecture in the manner described below.

FIG. 3 illustrates a exemplary stack architecture 30 for implementing an advanced metadata service across JXTA compliant peers. The stack architecture 30 includes an application programming interface 32, a metadata middleware 34, a content manager service 36, and a JXTA platform 38. The metadata middleware 34 is the layer which implements the needed metadata related services, such as the CRID resolution service and the advanced metadata service functions described above. The metadata middleware 34 also exposes the application programming interfaces 32 for these services to the content referencing applications residing on the peer.

The content management service 36 is a known JXTA service that supports the sharing and retrieval of content within a peer group. Each piece of shared content is referenced by a unique content identifier and represented by a content advertisement which provides metadata about the content. Rather than using a 128-bit MD5 hash as the content identifier, this exemplary implementation employs the hash of CRID as the content identifier. The content management service 36 manages the shared content for a local peer and allows application to browse and download content from other peers. To do so, it employs a protocol based on JXTA pipes for transferring content between peers. The content management service 36 is also interoperable with the remainder of the JXTA platform 38 in a manner known in the art, where the JXTA platform provides the basic underlying communication between peers.

Based on this type of architecture, an exemplary messaging scheme used by the AMS for sharing content amongst peers is further described below. First, it may be necessary for peers to discover the other peers in the network. In this case, a requesting peer may send a discovery query message as provided below:

<?xml version=”1.0” encoding=”UTF-8”?>
<jxta:DiscoveryQuery>
<Type>Peer</Type>
</jxta:DiscoveryQuery>

In response to this message, the requesting application will receive a list of accessible peers. An exemplary response message is as follows:

```
<?xml version=”1.0” encoding=”UTF-8”?>
<jxta:DiscoveryResponse>
      <Type> Peer </Type>
      <Count> 17 </Count>
      <PeerAdv> advertisement of the respondent <PeerAdv>
    <Response>
        accessible peer advertisement
    </Response>
</jxta:DiscoveryResponse>
```

### Given a list of peers, it is possible for an application to send messages to any of the accessible peers as well as listen for messages from these peers.

To identify content of interest, a requesting application may send search queries to the CRID resolution service 14. In some instances, a specific search query (e.g., keywords in the title of the content) may be sent to the CRID resolution service as described above. In other instances, one or more global search queries may be needed to identify the content of interest. In any case, the search queries are preferably formulated as XPath requests.

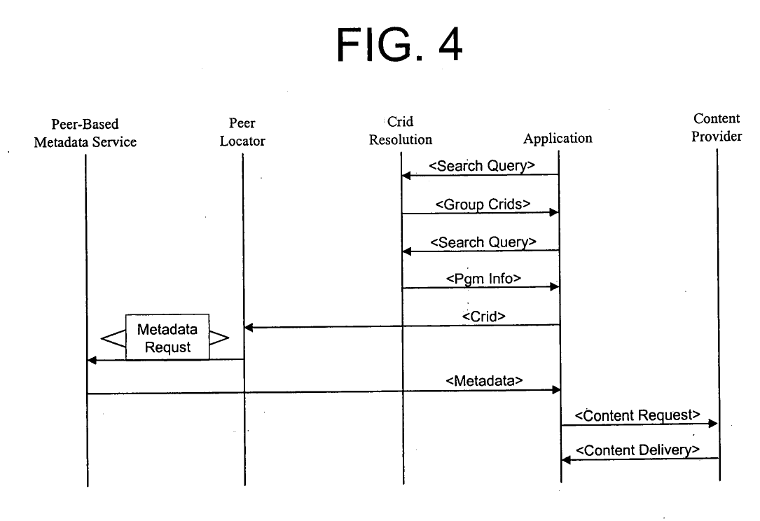

Referring to FIG. 4, a requesting application may begin by requesting information about the different groups of content. A search query for identifying groups having the word “movies” in the title of the groups may be formulated as follows:

```
<?xml version=”1.0” encoding=”UTF-8”?>
<tvams:SearchQuery>
    <XPath>
        //GroupInformation[.//Title contains “Movies”]
    </XPath>
</tvams:Search Query >
```

In response to this query, the CRID resolution service will provide a list of content groups in a response message as follows:

```
<?xml version=“1.0” encoding=“UTF-8”?>
<tvams:SearchResponse>
    <TVAMain>
      <GroupInformation crid=“crid://Fantasy-Movies”>
        <Title> Fantasy-Movies <Title>
        <Genre> fantasy </Genre>
        ...
      </GroupInformation>
      <GroupInformation crid=”crid://RealLife-Movies”>
      ...
      </GroupInformation>
    </TVAMain>
</tvams:SearchResponse>
```

### It is noteworthy that there is no content location metadata associated with the group CRIDs in these responses.

Given a group CRID, the requesting application may request program information for content found in this group. The search query to obtain the program information follows:

```
<?xml version=“1.0” encoding=“UTF-8”?>
<tvams:SearchQuery>
    <XPath>
          / / ProgramInformation [. / /MemberOf /crid =
        “crid://Fantasy-Movies”]
    </XPath>
</tvams:SearchQuery>
```

In this example, the requesting application is interested in movies found in the group entitled “Fantasy-Movies” and having a fantasy genre. The search query in turn yields the following response from the CRID resolution service:

```
<?xml version=“1.0” encoding=“UTF-8”?>
<tvams:SearchResponse>
<TVAMain>
    <ProgramInformation crid=“crid://StarWars-I”>
        <Title> StarWars-I <Title>
        <Genre> fantasy </Genre>
        <MemberOf crid=“crid://Fantasy-Movies”/>
        ...
    </ProgramInformation>
    <ProgramInformation crid=“crid://StarWars-II”>
    ...
    <ProgramInformation crid=“crid://WaterWorld”>
    ...
    <OnDemandProgram>
        <Program crid = “crid://StarWars-I” />
<ProgramURL>jxta://80.1.223.18/md5:123abc456def789ghi012jkl345m
no678</ProgramURL >
    </OnDemandProgram>
    <OnDemandProgram>
        <Program crid = “crid://StarWars-II” />
    <ProgramURL>jxta://80.1.223.19/md5:
    abasd456def7asdfhi012jkl34sd42895</ProgramURL >
    <ProgramURL>jxta://80.1.223.20/md5:
    abasd456def7asdfhi012jkl34sd42895</ProgramURL >
        </OnDemandProgram>
        <OnDemandProgram>
            <Program rid = “crid://WaterWorld”/>
    <ProgramURL>jxta://80.1.223.20/md5:
    abasd456def7asdfhadfadf12jk134sd42111</ProgramURL>
        </OnDemandProgram>
        ...
  </TVAMain>
</ tvams:SearchResponse>
```

A CRID is provided for each program found in the response. It is readily understood that other types of search queries or combinations of queries may be used to identify CRIDs for content of interest.

Next, a requesting application may use known CRIDs to access metadata, including content location metadata, for the content of interest. An advanced metadata service will be employed to resolve the CRID as discussed above. In other words, the peer locator service 18 first resolves the location of the applicable peer-based metadata service and then a request for metadata may then be directed to the peer hosting the applicable advanced metadata service 16. A exemplary request for content location metadata may be formulated as follows:

```
<?xml version=“1.0” encoding=“UTF-8”?>
<tvams:SearchQuery>
    <XPath>
        // On DemandProgram
          [./Program/@crid = “crid://WaterWorld”]
    </XPath>
</tvams:SearchQuery>
```

If there is content corresponding to the passed CRID, then a response from the advanced metadata service would look like:

```
<?xml version=“1.0” encoding=“UTF-8”?>
<tvams:SearchResponse>
    <TVAMain>
    <OnDemandProgram>
      <Program crid = “crid://WaterWorld” />
      <ProgramURL>
        jxta://80.1.223.21/md5:123abc456def789ghi012jkl345mno678
        </ProgramURL>
          <ProgramURL>
        jxta://80.1.223.23/md5:123abc456def789ghi012jkl345mno678
        </ProgramURL>
    </OnDemandProgram>
    </TVAMain>
</tvams:SearchResponse>
```

On the other hand, if there is no content for the passed CRID, then the response would be as follows:

<?xml version=“1.0” encoding=“UTF-8”?>
<tvams:SearchResponse>
<TVAMain></TVAMain>
</tvams:SearchResponse>

### In this example, the requesting application is requesting content location metadata.

A requesting application may also request other types of metadata. For instance, when the content location metadata specifies that the content of interest has been segmented amongst two or more different locations, a requesting application may request additional content segmentation data from the advanced metadata service. In this instance, a request for content segmentation data may be formulated as follows:

```
<?xml version=“1.0” encoding=“UTF-8”?>
<tvams:ContentSegmentsQuery>
    <cid> md5:123abc456def789ghi012jkl345mno678 </cid>
      <ProgramURL>
  jxta://80.1.223.21/md5:123abc456def789ghi012jkl345mno678
    </ProgramURL>
</tvams:ContentSegmentsQuery>
```

A response to such a query may look as follows:

```
<?xml version=“1.0”>
<!doctype tvacs:ContentAvailableSegments>
<tvams:ContentAvailableSegments>
    <cid> md5:123abc456def789ghi012jkl345mno678 </cid>
    <FileName> StarWars-XVI </FileName>
    <TotalFileSize> 12345 </TotalFileSize>
    <SegmentSize> 1024 </SegmentSize>
    <StartingSegmentIndex> 8 </StartingSegmentIndex>
    <EndingSegmentIndex> 64 </EndingSegmentIndex>
<tvams:?ContentAvailableSegments>
```

### It is readily understood that similar requests and responses may be formulated for other types of metadata which may be provided by the advanced metadata service.

Finally, the requesting application can retrieve the content of interest from the peer that has the data. In particular, a JXTA send message is sent from the requesting application to the content provider using the content location metadata provided by the advanced metadata service. An exemplary data request message may be as follows:

```
<?xml version=“1.0” encoding=“UTF-8”?>
<ContentQuery>
  <cid> md5:123abc456def789ghi012jkl345mno678 </cid>
  <StartingSegmentIndex> 9 </StartingSegmentIndex>
  <EndingSegmentIndex> 24 </EndingSegmentIndex>
<ContentQuery>
```

After receiving the JXTA send message, the content provider responds using a JXTA send message formatted as follows:

```
<?xml version=“1.0” encoding=“UTF-8”?>
<ContentResponse>
    <cid> md5:123abc456def789ghi012jkl345mno678 </cid>
    <StartingSegmentIndex> 9 </StartingSegmentIndex>
    <EndingSegmentIndex> 24 </EndingSegmentIndex>
    <Data> - content data - </Data>
<ContentResponse>
```

The following description is merely exemplary in nature and is not intended to limit the present disclosure, application, or uses. It should be understood that throughout the drawings, corresponding reference numerals indicate like or corresponding parts and features.

What is claimed is:

1. A method of retrieving metadata for content residing in a peer-to-peer network, comprising:
determining a content reference identifier for the content, where the content reference identifier is compliant with Uniform Resource Identifier syntax;
generating a hash value for the content reference identifier;
determining location of a peer-based metadata service based on the hash value, where the metadata service is responsible for additional metadata pertaining to the content;
retrieving metadata for the content by accessing the metadata service using the content reference identifier.

2. The method of claim 1 wherein the content reference identifier is further defined in accordance with TV-anytime specifications.

3. The method of claim 1 wherein determining a content reference identifier further comprises sending search criteria for content to a content identifier resolution service, and receiving back from the content identifier resolution service one or more content reference identifiers for the content based on the search criteria.

4. The method of claim 1 wherein generating a hash value for the content reference identifier further comprises applying a one-way hash function to the content reference identifier.

5. The method of claim 1 further comprises
defining ranges of hash values for content reference identifiers which may be used in the network;
assigning different peers in the network to different defined ranges of hash values;
configuring each assigned peer with a metadata service, where the metadata service resolves content reference identifiers whose hash values fall within the range of hash values assigned to the peer.

6. The method of claim 6 wherein determining location of a metadata service further comprises maintaining a data store which contains an identifier for each assigned peer and a corresponding range of hash values assigned to the peer, and retrieving an identifier for a peer hosting an applicable metadata service by assessing the data store using the hash value for the content reference identifier.

7. The method of claim 1 comprises sending a search query for different types of content to a content identifier resolution service and receiving a list of different types of available content.

8. The method of claim 1 further comprises sending a search query that identifies a type of content and receiving a list of content reference identifiers that fall within the specified group.

9. The method of claim 1 wherein retrieving metadata further comprises sending a query for content location metadata to an applicable metadata service and receiving a Uniform Resource Locator (URL) for the content in response to the query.

10. The method of claim 9 further comprises sending a request for content to a content provider using the URL for the content.

11. The method of claim 10 wherein sending a request for content is formulated as a JXTA message.

12. The method of claim 1 wherein retrieving metadata further comprises sending a query for content segmentation metadata to an applicable metadata service.

13. A method for scaling metadata services in a peer-to-peer network, comprising:
defining ranges of hash values for content reference identifiers which may be used in the network;
assigning a peer within the network to each defined range of hash values;
configuring each assigned peer with a peer-based metadata service, where the metadata service resolves content reference identifiers whose hash values fall within the range of hash values assigned to the peer.

14. The method of claim 13 wherein the content reference identifiers are compliant with Uniform Resource Identifier syntax and defined in accordance with TV-anytime specifications.

15. The method of claim 13 further comprises assessing metadata for a given instance of content by determining a content reference identifier for the content, generating a hash value for the content reference identifier and querying an applicable metadata service using the hash value.

16. A metadata management architecture for peer-to-peer networks, comprising:
a plurality of peer-based metadata services distributed amongst the peers of the network, where each metadata service resides on a given peer and is operable to resolve content reference identifiers whose hash values fall within a range of hash values assigned to the given peer; and
a peer locator table accessible to peers in the network, the peer locator table contains different ranges of hash values for content reference identifiers and a peer identifier for each range of hash values, such that the peer identifier correlates to the peer that is responsible for resolving the content reference identifiers whose hash values fall within the corresponding range of hash values.

17. The metadata management architecture of claim 16 wherein the metadata service on a given peer resides in a stack architecture and is interposed between an application programming interface and a content manager service as defined in accordance with a JXTA protocol.
